(19) United States
(12) Patent Application Publication
(10) Pub. No.: US 2010/0012732 A1
(43) Pub. Date: Jan. 21, 2010

(54) INSTALLING A PATCH IN A SMART CARD MODULE

(75) Inventors: Robert Pinzinger, Munchen (DE); Jörn Treger, Rosenheim (DE); Ludger Holtmann, Hohenlinden (DE)

Correspondence Address: MARTINE PENILLA & GENCARELLA, LLP, 710 LAKEWAY DRIVE, SUITE 200, SUNNYVALE, CA, 94085, US

(73) Assignee: GIESECKE & DEVRIENT GMBH, München (DE)

(21) Appl. No.: 12/449,142

(22) PCT Filed: Jan. 18, 2008
(86) PCT No.: PCT/EP2008/000387

§ 371 Date: Jul. 24, 2009

(30) Foreign Application Priority Data
Jan. 24, 2007 (DE) 10 2007 003 580.4

(51) Int. Cl. G06K 19/06; G06F 9/445; H04L 9/32; G06F 21/00

(52) U.S. Cl. 235/492; 717/168; 713/176

(57) ABSTRACT

In a method for installing a patch in a smart card module, a loading routine is used to load a pseudo application containing the patch into the smart card module. An installation routine contained in the pseudo application is called, with the installation routine notifying a patch routine contained in the system programs of the smart card module of the patch to install the patch in a location outside the pseudo application. The technique can be used to install the patch in the field and requires only little effort and only few modifications to existing components and structures.

The invention generally relates to the technical field of installing patches in smart card modules. A smart card module, in the terminology of the present document, may be constructed as a chip card or a compact chip module.

Smart card modules are used for a multitude of applications. Apart from the originally prevalent embodiments as chip cards or plug-in chip modules—e.g. SIMs for cellular telephones—smart card modules that are intended for permanent integration into devices are being developed to an increasing extent. Such built-in modules may for example be designed as NFC modules (NFC=Near Field Communications), which combine the function of a smart card with a short-range wireless communication interface. Once a device with a built-in smart card module—e.g. a cellular telephone with a soldered-in smart card module—has been manufactured, the smart card module cannot be detached from the device any more, or only with considerable effort.

Many designs of smart card modules comprise system programs that provide a runtime environment for executing applications, and a loading program for loading applications into the smart card module. Such smart card modules are known, for example, under the brand name Java Card. The document “Runtime Environment Specification Java Card™ Platform, Version 2.2.2”, March 2006, published by Sun Microsystems, Inc., Santa Clara, USA, describes the runtime environment including the loading program in Java Card modules.

Many smart card modules contain comprehensive and complex software. This particularly applies to Java Card modules, because they are relatively complex and are therefore used primarily for sophisticated tasks. Even if the software contained in a smart card module is prepared with great care, errors cannot be ruled out completely. In order to correct such errors prior to the delivery of the smart card module, it is known to load patches into the module during the completion or the initialization of the smart card module. In this regard, according to common parlance, a “patch” refers to program code which does not represent a self-contained system or application program, but which serves the purpose of modifying an existing program, in particular for error correction or functional extension.

However, the above-mentioned way of patching cannot be used any more after the completion or initialization of the smart card module. If a serious error is not discovered until after that point in time, a replacement of the smart card module may become necessary. In the case of a smart card module having a chip card design, the problem is less one of the costs for a new chip card, it is rather the logistical effort caused when the chip card is already in the possession of the end consumer. However, if a smart card module which is firmly built-in into a device is concerned, such as, for example, an NFC module, then many devices that were already manufactured are possibly unserviceable or very limited with regard to their functionality. Depending on the value of the devices, this may result in great damage.

Of course, a new generation of smart card modules and a specially adapted background system that provide a function for patching the smart card modules in the field could in principle be developed. However, this approach would be technically complex, expensive and time-consuming. There is therefore a need for a way of patching which can be used with as little effort and as few modifications as possible in smart card modules commonly used today—e.g. Java Card modules—and background systems commonly used today.

U.S. Pat. No. 6,202,208 discloses a technique for patching a program which is executed by a Java™ Virtual Machine—that is, not by a Java Card Virtual Machine—, usually on a PC or, in any case, a system not limited as regards its hardware resources. When a patch is deployed, at least one entry is modified in a method table of the program so that the modified entry refers to a method body provided by the patch. In this manner, the program can be modified during operation. This functionality is important, for example, in telecommunication exchange installations, where the occurrence of downtimes is to be avoided, if possible.

It is the object of the invention to provide a technique for installing a patch in a smart card module even after the completion or initialization of the smart card module, wherein the technique requires only little effort and few modifications to existing components and structures.

According to the invention, this object is accomplished by a method comprising the features of claim 1, a method comprising the features of claim 11, and a smart card module comprising the features of claim 12. The dependent claims relate to optional features of some embodiments of the invention.

The invention is based on the basic concept of using the function of the smart card module for loading applications, which is known as such, also for loading the patch into the smart card module. According to the invention, it is provided to load a pseudo application containing the patch into the smart card module by means of a loading program, and to call an installation routine contained in the pseudo application, said installation routine notifying a patch routine of the patch to install the patch in a location outside the pseudo application, wherein the patch routine is contained in the system programs.

The “packaging” according to the invention of the patch into the pseudo application has the considerable advantage that functions and structures known as such, as they are common, for example, in smart card modules according to the Java Card standard, are being used to obtain the patch functionality. In some embodiments, for example, only the patch routine needs to be newly developed, and this patch routine can also be based on already existing functions for loading patches during the initialization and/or completion of the smart card module. The loading program, which is actually intended for loading regular applications, can be used in some embodiments without any modifications also for loading the pseudo application containing the patch.

The method according to the invention is transparent for the outside world. The patch packaged in the pseudo application can therefore be loaded into the smart card module in any manner, for example in an OTA loading process (OTA=over the air).

In some embodiments, the patch is provided for at least one of the system programs of the smart card module. For example, the patch can be written into a separate patch area in a non-volatile rewriteable memory of the smart card module.

In some embodiments, the patch is protected by a signature. An identifier may be provided alternatively or additionally, which ensures that only an uninterrupted sequence of patches that build upon one another can be installed. Generally, any cryptographic check sums and authentications can be used in order to protect the method against unauthorized modification of the programs stored in the smart card module.

In the exemplary embodiments of the present document, mainly smart card modules according to the Java Card standard are described. However, the invention is also suitable for use in other smart card modules having similar structures. These may include, for example, smart card modules according to the .NET standard.

Other features, advantages and objects of the invention will become apparent from the following detailed description of an exemplary embodiment and several alternative embodiments. Reference is made to the schematic illustrations, in which:

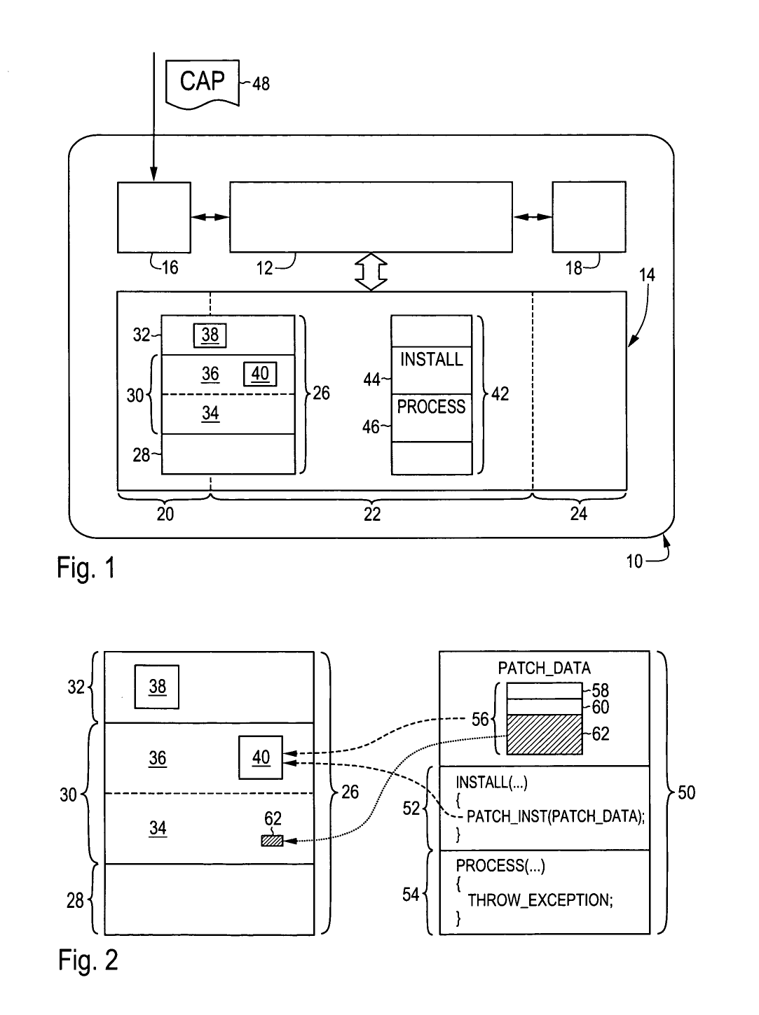

FIG. 1 shows a block diagram with functional units of a smart card module according to one exemplary embodiment of the invention,

FIG. 2 shows a representation of the system programs and of the pseudo application in the memory of the smart card module according to FIG. 1 during the installation of the patch, and

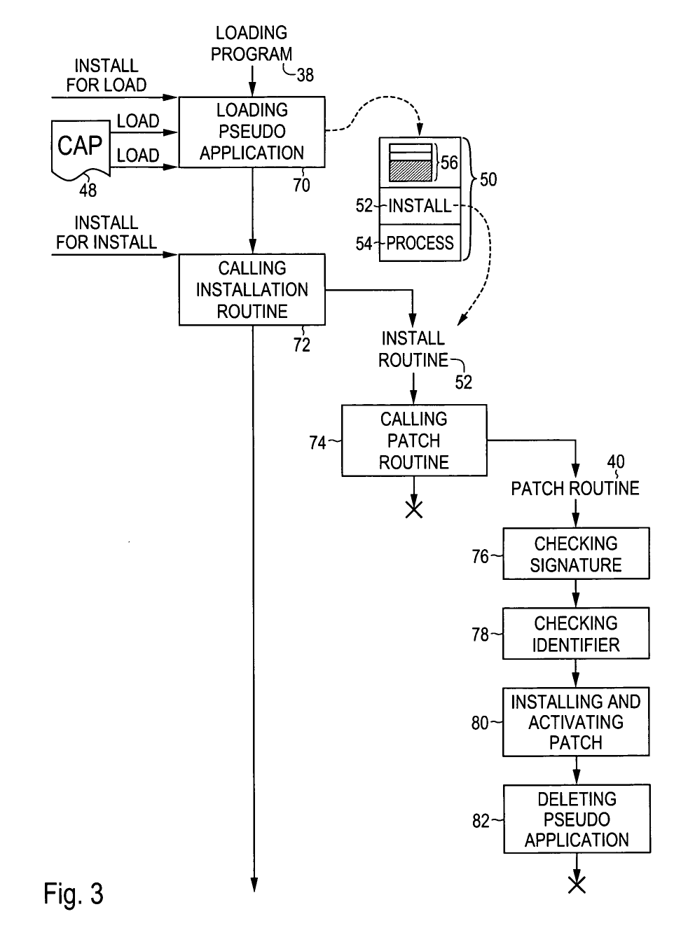

FIG. 3 shows a flow chart of a method for installing a patch in the smart card module according to FIG. 1.

In the present exemplary embodiment, the smart card module 10 shown in FIG. 1 is configured as a chip module to be soldered in into a host device, e.g. a cellular telephone. The smart card module 10 has a processor 12, a memory 14, a host interface 16 and a radio interface 18. In this case, the host interface 16 is used for the line-based communication with the host device, whereas the radio interface 18 serves for short-range wireless communication (NFC=Near Field Communications) with an external terminal.

The memory 14 is subdivided into several memory fields. In the present exemplary embodiment, a read-only memory 20 configured as a ROM, a non-volatile rewriteable memory 22 configured as an EEPROM and a working memory 24 configured as a RAM are provided as memory fields.

The smart card module 10 is designed in accordance with the Java Card standard. It comprises comprehensive system programs 26 which are in part located in the read-only memory 20 and in part in the non-volatile rewriteable memory 22 and which access data in the working memory 24. The system programs 26 form an operating system 28, a runtime environment 30 and a set of auxiliary programs 32. The operating system 28 provides functions that are close to hardware level and which are used by the runtime environment 30 and the auxiliary programs 32. The runtime environment 30 has a virtual machine 34, which in the present sample embodiment is designed as a JCVM (Java Card Virtual Machine). Furthermore, a class library 36, which provides application programming interfaces, is provided as a part of the runtime environment 30.

A loading program 38 (installer) and a patch routine 40, the mode of operation of which will be described in detail below, are contained in the system programs 26. In the exemplary embodiment according to FIG. 1, the patch routine 40 is a part of the class library 36, whereas the loading program 38 is configured as one of the auxiliary programs. In alternative embodiments, the loading program 38 and/or the patch routine 40 can be contained in other conceptual units of the system programs 26.

Apart from the patch routine 40, all the system programs 26 are common components of a Java Card module. The patch routine 40 can already be provided during the production of the smart card module 10. However, embodiments in which the patch routine 40 is loaded into the non-volatile rewriteable memory 22 at a later point in time, for example, during the completion or initialization of the smart card module 10, are also possible. For this purpose, a patch function according to the prior art may be used, for example. Such embodiments have the advantage that the patch functionality according to the invention can be implemented in a totally common Java Card module.

The smart card module 10 is designed for receiving several applications in the non-volatile rewriteable memory 22—only one application 42 is shown in FIG. 1 by way of example. In the present exemplary embodiment, every application 42 is designed as a Java Card Applet and derived from the class javacard.framework.Applet. Every application 42 comprises several methods, which in FIG. 1 are indicated by horizontal partitions. In particular, an installation routine 44 and a processing routine 46 are contained in every application 42.

The installation routine 44 in the present exemplary embodiment is a method named “install”, which in accordance with the Java Card standard is called after loading the application 42 in order to generate an instance of the application 42 and register it with the runtime environment. The processing routine 46 designed as a method named “process” interprets and processes incoming command APDU's (APDU=Application Protocol Data Unit) directed to the application 42. As a rule, the application 42 comprises further routines, for example methods named “select” and “deselect”, which, however, are of no further interest here.

The loading program 38 (installer) serves for loading further applications into the smart card module 10. In the present exemplary embodiments, the loading program 38 is an installer according to the Java Card standard known as such, such as it is described, for example, in the document “Runtime Environment Specification Java Card™ Platform, Version 2.2.2” mentioned in the introduction. In relation to its environment, the loading program 38 behaves like an application executed by the smart card module 10, even if it is part of the system programs 26 according to the terminology of the present document.

The loading program 38 contains an application in the form of a program package 48 in the CAP format (CAP=Converted Applet), which is to be loaded into the smart card module 10. In order to load the application, the loading program 38 is first selected. If—as is common—commands according to the GP (Global Platform) specification are used, the loading process is then effected by the command APDU “INSTALL FOR LOAD”, followed by one or more command APDUs “LOAD”. After the new program package 48 has been successfully loaded into the non-volatile rewriteable memory 22, it is installed by means of the command APDU “INSTALL FOR INSTALL”. In the process, the installation routine—in the present case the “install” method—of the new application is executed. If another standard is taken as a basis, commands that look different but have the same function take the place of the above-mentioned GP conforming commands.

The process for retroactively loading applications into the smart card module 10, which was just outlined briefly, is known as such from the Java Card Standard. In the exemplary embodiment described herein, this loading process is used, however, to load a patch—that is, a patch for a system or application program already located in the smart card module 10—into the smart card module 10 and install it there. According to the invention, the use of a pseudo application 50 is provided for this purpose.

The structure of the pseudo application 50 shown in FIG. 2 corresponds to that of a regular application 42. In particular, the pseudo application 50 has an installation routine 52 designed as an “install” method and a processing routine 54 designed as a “process” method. Furthermore, patch data 56 are contained in the pseudo application 50 which in the present exemplary embodiment 58 are subdivided into a signature 58, an identifier 60 and the actual patch 62. Expediently, the patch 62 is present in encrypted form. Preferably, encryption is carried out using a symmetric method. Expediently, the keys required for the decryption of a patch 62 can in that case be loaded in advance into the non-volatile memory 22 together with the patch routine 40. The signature 58 covers both the identifier 60 and the patch 62 and constitutes a protection against unauthorized manipulation. Instead of a single signature 58, several signatures can readily be provided which may be allocated to, for example, different users of the system programs 26 or the runtime environment 30.

In contrast to a regular application 42, the pseudo application 50 is not designed for processing command APDUs. The processing routine 54 of the pseudo application 50 therefore exists only formally, and consists of only one instruction triggering an exception handling. This instruction can read as follows, for example:
ISOException.throwIt(ISO7816.SW_FUNC_NOT_SUPPORTED);

The installation routine 52 carries out the actual task of the pseudo application 50. In the present exemplary embodiment, this task consists of the installation routine 52, once it is called during the loading of the pseudo application 50 into the smart card module 10, calling the patch routine 40 and passing the patch data 56, or a reference directed to the patch data 56, to it. This process is indicated by the dashed arrows in FIG. 2.

The patch routine 40 thereupon verifies the patch data 56. In the process, it ensures by means of suitable methods that the patch data 56 are in order and that all requirements for the installation of the patch 62 are satisfied. In particular, the patch routine 40 checks that the signature 58 is correct and that the identifier 60 is valid, and decrypts the patch 62 if it is encrypted. If the check and the decryption proceed successfully, the patch routine 40 installs the patch 62 in the non-volatile memory 22 of the smart card module 10. This is shown by the dotted arrow in FIG. 2. The memory area in which the patch 62 is to be installed can be indicated, for example, in the identifier 60 or in the patch 62 or in other components of the patch data 56 not shown in FIG. 2.

The division of the functions just described between the installation routine 52 and the patch routine 40 ensures that the security-critical deployment of the patch 62 into the smart card module 10 only takes place after a successful verification by the patch routine 40. It should be understood that, in alternative embodiments, the steps connected with the deployment of the patch 62 can be divided differently between the installation routine 52 and the patch routine 40, as well as, where applicable, other routines. As a rule, the use of a patch routine 40 contained in the system programs 26 is required in order to be able to install the patch 62 outside of the pseudo application 50, in particular in the system programs 26 or, in some embodiments, also in other applications.

FIG. 3 shows in more detail the steps just described briefly of installing the patch 62 in the smart card module 10. The sequence is triggered in step 70 by the loading program 38 receiving the command APDU “INSTALL FOR LOAD”. The program package 48 with the pseudo application 50 is thereupon transferred into the smart card module 10 with one or more “LOAD” commands. In the process, the pseudo application 50 is established in the non-volatile rewritable memory 22.

In the following step 72, the loading program 38 receives the command APDU “INSTALL FOR LOAD”. The loading program 38 processes this command APDU and in the process calls the installation routine 52, that is, the “install” method of the pseudo application 50. In step 74, the installation routine 52 in turn calls the patch routine 40 and notifies it of the patch 62 by the installation routine 52 transferring to the patch routine 40 a reference directed to the patch data 56.

The installation routine 52 of the pseudo application 50 does not need to carry out the registration (calling of the method Applet.register) common in regular applications. This is because, in contrast to regular applications, the pseudo application 50 does not need to be selectable, and it is therefore not necessary to register the pseudo application 50 in the registration file (registry) of the system programs 26.

After being called, the patch routine 40 first checks, in step 76, the correctness of the signature 58 or signatures. Both the identifier 60 as well as the actual patch 62 are verified for this purpose. If it is encrypted, the patch 62 is first decrypted for this purpose. If the signature check in step 76 was successful, the patch routine 40 checks the identifier 60 in step 78. Expediently, the identifier 60 contains a sequence number of all patches for the smart card module 10 called patch level. In step 78, a check is then performed whether the sequence number of the patch 62 currently intended for installation is an admissible number with respect to the sequence of numbers of the already existing patches; in the simplest embodiment, it may be checked, for example, whether the sequence number is equal to the next higher number of the last patch installed in the smart card module 10. If the number is admissible, that is, if there is a consistent chain of patches for example, the current patch 62 can be installed. If one of the two checking steps 76 and 78 fails, the process is aborted.

Installation and activation of the patch 62 take place in step 80. A method known as such may be used for this purpose. In many embodiments, the smart card module 10 comprises a separate patch area in the non-volatile rewriteable memory 22 into which the patch 62 is written and which is activated by suitable jump targets being set. However, other techniques can also be used for executing the actual patching process.

Following a successful installation of the patch in step 80, the pseudo application 50 is deleted in an optional step 82, thus freeing the memory space occupied by the pseudo application 50. The deleting program (Applet Deletion Manager) provided according to the Java Card standard is used for this purpose. However, embodiments in which the pseudo application 50 is not deleted are also provided.

The background system can now be notified of the successful installation of the patch 62 by a response APDU.

It should be understood that the embodiments and variants of embodiments described herein are only to be considered examples. Other modifications and combinations of the features described herein are immediately apparent to the person skilled in the art.

1. A method for installing a patch in a smart card module, wherein the smart card module comprises system programs which provide a runtime environment for executing applications in the smart card module and a loading program for loading applications into the smart card module, comprising the steps of:
utilizing the loading program for loading a pseudo application containing the patch into the smart card module, and
calling an installation routine contained in the pseudo application, said installation routine notifying a patch routine of the patch to install the patch at a location outside of the pseudo application, said patch routine being contained in the system programs.

2. The method according to claim 1, wherein the patch routine installs the patch in at least one of the system programs.

3. The method according to claim 1, wherein the system programs comprise an operating system, a virtual machine and a class library.

4. The method according to claim 1, wherein the smart card module comprises a non-volatile rewritable memory, and wherein the patch routine writes the patch into an area of the non-volatile rewritable memory.

5. The method according to claim 1, wherein every application loaded into the smart card module provides an installation routine which is called during the loading of the application, and wherein the installation routine of the pseudo application is called in the same way as the installation routine of a regular application.

6. The method according to claim 1, wherein an identifier is allocated to the patch, and wherein the patch is installed only if the identifier indicates that the immediately preceding patch was already installed.

7. The method according to claim 1, wherein a signature is allocated to the patch, and wherein the patch is installed only after a successful check of the signature.

8. The method according to claim 1, wherein the patch is provided in an encrypted form.

9. The method according to claim 6, wherein the signature, the identifier and the patch are contained in the pseudo application.

10. The method according to claim 1, wherein the smart card module is configured as a Java Card.

11. The method according to claim 10, wherein the pseudo application is loaded into the smart card module as a program package in the CAP format.

12. A method for completing and/or initializing a smart card module, wherein the smart card module comprises system programs which provide a runtime environment for executing applications in the smart card module and a loading program for loading applications into the smart card module, wherein a patch routine is loaded into the system programs of the smart card module, said patch routine being designed to be used for installing a patch, wherein said patch routine is designed to be called by an installation routine contained in a pseudo application that is loaded into the smart card module at a time after completion and/or initialization of the smart card module, and wherein said patch routine is designed to install the patch at a location outside of the pseudo application, in response to being notified by the installation routine of the patch.

13. The method according to claim 12, wherein the smart card module comprises a non-volatile rewritable wherein the patch routine is designed to write the patch into an area of the non-volatile rewritable memory.

14. The method according to claim 12, wherein every application loaded into the smart card module provides an installation routine which is called during the loading of the application, and wherein the installation routine of the pseudo application is designed to be called in the same way as the installation routine of a regular application.

15. The method according to claim 12, wherein the smart card module is configured as a Java Card.

16. A smart card module comprising a processor, a memory and a host interface, wherein the smart card module comprises system programs which provide a runtime environment for executing applications in the smart card module and a loading program for loading applications into the smart card module, and wherein the smart card module is designed for executing a method for installing a patch in the smart card module, comprising the steps of:
utilizing the loading program for loading a pseudo application containing the patch into the smart card module, and
calling an installation routine contained in the pseudo application, said installation routine notifying a patch routine of the patch to install the patch at a location outside of the pseudo application, said patch routine being contained in the system programs.

17. The smart card module according to claim 16, wherein the smart card module is configured as a NFC module and comprises a radio interface.

18. The smart card module according to claim 16, wherein the smart card module comprises a non-volatile rewritable memory, and wherein the patch routine is designed to write the patch into an area of the non-volatile rewritable memory.

19. The smart card module according to claim 16, wherein every application loaded into the smart card module provides an installation routine which is called during the loading of the application, and wherein the installation routine of the pseudo application is designed to be called in the same way as the installation routine of a regular application.

20. The smart card module according to claim 16, wherein the smart card module is configured as a Java Card.
